(19) United States
(12) Patent Application Publication
(10) Pub. No.: US 2005/0120081 A1
(43) Pub. Date: Jun. 2, 2005

(54) Building control system having fault tolerant clients

(76) Inventor: Amy L. Ikenn, Kideer, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/950,944

(22) Filed: Sep. 27, 2004

Related U.S. Application Data
(60) Provisional application No. 60/506,692, filed on Sep. 26, 2003.

(51) Int. Cl. G06F 15/16

(52) U.S. Cl. 709/203; 707/9; 700/90

(57) ABSTRACT

A building control system is provided with one or more clients which are converted to become fault tolerant servers by replicating system data into the clients. The fault tolerant servers may be grouped with one or more clients each such that fault tolerant servers and associated clients function as groups when communications between the database server of the building control system and the fault tolerant server and the clients are interrupted. In this way, the fault tolerant server and the clients can continue functioning when disconnected from the database server.

### CROSS-REFERENCE TO RELATED APPLICATIONS

This application claims the benefit of U.S. Provisional Patent Application Ser. No. 60/506,692, filed Sep. 26, 2003, which is incorporated herein by reference.

Cross-reference is made to co-pending application, U.S. patent application Ser. No. 10/434,390 filed on May 8, 2003 titled “Integrated Communication of Building Control System and Fire Safety System Information”, which is owned by the owner of the present application and incorporated herein by reference. Cross-reference is also made to co-pending application, U.S. patent application Ser. No. 10/671,234, field on Sep. 25, 2003 entitled “Ethernet—Based Fire System Network”, which is owned by the owner of the present application and incorporated herein by reference. Cross-reference is also made to co-pending application, U.S. patent application Ser. No. 10/199,802, filed on Jul. 19, 2002 entitled User Interface for Fire Detection System” which is owned by the owner of the present application and incorporated herein by reference.

### FIELD OF THE INVENTION

The present invention relates to a building control system provided with fault-tolerant workstations that can continue to control and monitor building subsystems even when disconnected from the building control systems database server.

### BACKGROUND OF THE INVENTION

The problem with existing building control systems is that workstations, otherwise known as clients, cannot function to control and monitor the building subsystems they are provided for if they are unable to communicate with the database server of the building control system. Industries such as pharmaceutical manufacturing rely upon building control systems to verify that the environmental conditions within their manufacturing facilities remain within required parameters. The biggest obstacle for clients to operate independently when communications to and from the database server is that all of the data for the entire system is stored at the database server. While hardware redundancy may work in some circumstances, hardware redundancy is not effective if clients before separated from the database server due to a network failure. Accordingly, what is needed is a building control system whereby clients maintain at least minimal control and monitoring ability when communications between the client and the database server are lost.

### SUMMARY OF THE INVENTION

The present invention relates to a building control system comprising a database server and one or more clients that have been converted to fault tolerant servers by replicating system data into the one or more clients, and providing the clients with lockservers. The fault tolerant servers may be grouped with other clients so that the fault tolerant servers and the clients can function as a group when communications from the database server are lost. Each fault tolerant server is provided with a lockserver, a job database which includes information such as system security, and data for system devices to be controlled and monitored, such as lower level controllers, commonly referred to as field panels in the building control industry, and building level network information.

In another embodiment, the present invention may be implemented in a life safety system, so that clients can view and respond to alarms when communications are interrupted between clients and the database server.

In yet another embodiment, a method of converting a client into a fault tolerant client is shown. The method includes determining which databases in said databases server need to be replicated into a client such that the client can operate as a fault-tolerant server, determining available disk space for said client, establishing appropriate partitions in the database of the client, establishing appropriate partitions in the database of the client, replicating databases from said database server into said fault tolerant server database, the databases including information about one or more clients grouped with the fault tolerant server such that the fault tolerant server and the fault tolerant clients can communicate when the clients and the fault tolerant server are unable to communicate with the database server, establishing weights on each database, and starting the lockserver transferred to the fault-tolerant server

### BRIEF DESCRIPTION OF THE DRAWINGS

FIG. 1 shows a block diagram of an exemplary building control system in which the principles of the subject invention are utilized;

FIG. 2 is a block diagram of an exemplary building control system in which workstations are shown with sufficient data to operate independently of a database server;

FIG. 3 is a flow diagram of an exemplary manner of converting a non-fault tolerant client to a fault tolerant client; and

FIG. 4 is a block diagram of an exemplary life safety system in which the principles of the present invention are utilized.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

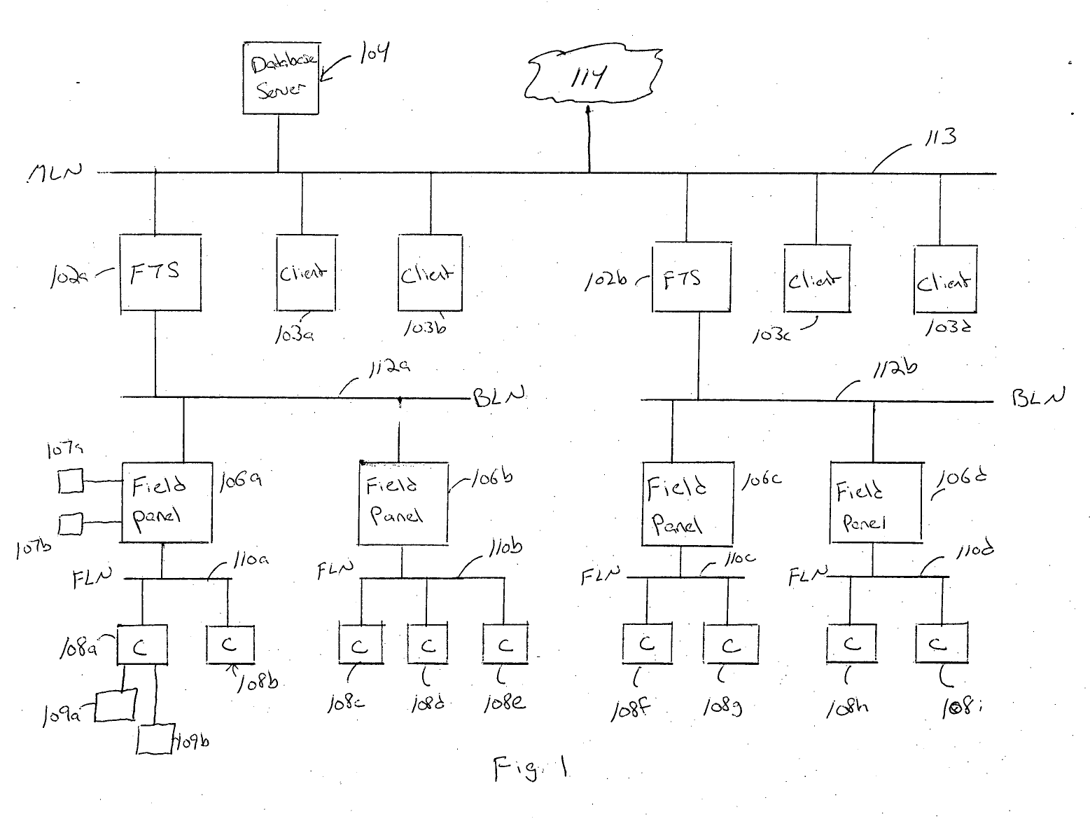

FIG. 1 depicts a system block diagram of an exemplary building control system (BCS) 100 in which the subject invention may be used. The building control system 100 is depicted as a distributed building system that provides control functions for any one of a plurality of building operations. Building control systems may thus include HVAC systems, security systems, life or fire safety systems, industrial control systems and/or the like. An example of a BCS is the APOGEE™ system available from Siemens Building Technologies, Inc. of Buffalo Grove, Ill. The APOGEE™ system allows the setting and/or changing of various controls of the system, generally as provided below. It should be appreciated that the building control system 100 is only an exemplary form or configuration for a building control system. Therefore, the principles of the subject invention are applicable to other configurations and/or forms of building control systems.

The building control system 100 includes at least one supervisory control system or workstation, though in the present embodiment workstations 102a and 102b are shown. Workstations 103a, 103b, 103c and 103d are provided as monitoring stations that allow users to monitor the condition of points in the building control system 100. Building control system 100 further comprises a system database server 104, a plurality of field panels represented by field panels 106a and 106b, and a plurality of controllers represented by controllers 108a-108i. It will be appreciated, however, that wide varieties of BCS architectures may be employed. When all communications are intact, any workstation (104, 102a-b, 103a-d) can be used to control and monitor and provide a user interface for all of the devices in BCS 100. While FIG. 1 shows workstations 102a and 102b being directly connected to BLN 112a and BLN 112b respectively, it is understood that the hardware connections between the workstations need not be between workstations 102a-102b to the BLN networks 112a, 112b, but can be from workstations 103a-103d such that workstations 102a-102b do not need to be directly connected through hardware to the BLN networks 112a and 112b.

Each of the controllers 108a-108i corresponds to one of plurality of localized, standard building control subsystems, such as space temperature control subsystems, lighting control subsystems, or the like. Suitable controllers for building control subsystems include, for example, the model TEC (Terminal Equipment Controller) available from Siemens Building Technologies, Inc., of Buffalo Grove, Ill. To carry out control of its associated subsystem, each controller 108a-108i connects to one or more sensors and/or actuators, shown by way of example as the sensor 109a and the actuator 109b connected to the controller 108a.

Typically, a controller such as the controller 108a effects control of a subsystem based on sensed conditions and desired set point conditions. The controller controls the operation of one or more actuators to attempt to bring the sensed condition to the desired set point condition. By way of example, consider a temperature control subsystem that is controlled by the controller 108a, where the actuator 109b is connected to an air conditioning damper and the sensor 109a is a room temperature sensor. If the sensed temperature as provided by the sensor 109a is not equal to a desired temperature set point, then the controller 108a may further open or close the air conditioning damper via actuator 109b to attempt to bring the temperature closer to the desired set point. Such systems are known. It is noted that in the BCS 100, sensor, actuator and set point information may be shared between controllers 108a-108i, the field panels 106a-106d, workstations 102a-102b, monitoring workstations 103a-103d, and any other elements on or connected to the BCS 100.

To facilitate the sharing of such information, groups of subsystems such as those connected to controllers 108a and 108b are typically organized into floor level networks (“FLNs”) and generally interface to the field panel 106a. The FLN data network 110a is a low-level data network that may suitably employ any suitable proprietary or open protocol. Controllers 108c, 108d and 108e along with the field panel 106b are similarly connected via another low-level FLN data network 110b. Controllers 108f and 108g along with the field panel 106c are similarly connected to FLN network 110c and controllers 108h and 108i are similarly connected to FLN data network 110d. Again, it should be appreciated that wide varieties of FLN architectures may be employed.

The field panels 106a and 106b are also connected via a building level network (“BLN”) 112a to the workstation 102a which provides connection to the database server 104. Field panel 106c and 106d are connected via BLN 112b to workstation 102b which provides connection to database server 104. Typically such field panels, for example field panels 106a and 106b, coordinate the communication of data and control signals between the controllers 108a-108e and the supervisory computer 102a and database server 104. In addition, one or more of the field panels 106a, 106b may themselves contain control programs for controlling HVAC actuators such as those associated with air handlers or the like. To this end, as shown in FIG. 1, the field panel 106a is operably connected to one or more HVAC system devices, shown for example as a sensor 107a and an actuator 107b.

The workstations 102a-102b provide overall control and monitoring of the building control system 100 and include a user interface. The workstations 103a-d also provide a user interface and can be used to control and monitor the devices connected through 102a and 102b. The workstations 102a-102b further operate as a BCS data server that exchanges data with various elements of the BCS 100. The BCS data server can also exchange data with the database server 104 when communications are available. The BCS data server of each workstation allows access to the BCS system data by various applications. Such applications may be executed on the workstations 102a-102b or other supervisory computers, not shown, connected via a management level network (“MLN”) 113.

When the database server 104 is available, typically a workstation, workstation 102a for example, is a user access point for the system components (including the field panels 106a and 106b), is operative to accept modifications, changes, alterations and/or the like (“workstation events”) from the user. This is typically accomplished via a user interface for or of the workstation 102a. The user interface may be the keyboard of the workstation 102a. The workstation 102a is operable to, among other things, affect or change operational data of the field panels 106a, 106b as well as other components of the BCS 100. The field panels 106a and 106b utilize the data and/or instructions from the workstation 102a to provide control of connected devices such as devices 107a and 107b and/or the controllers 108a and 108b. Field panels 106c and 106d and workstation 102b operate in a similar fashion.

The workstation 102a is also operative to poll or query the field panels 106a and 106b for gathering data. The workstation 102a processes the data received from the field panels 106a and 106b, including maintaining a log of field panel events and/or logging thereof. Information and/or data is thus gathered from the field panels 106a and 106b in connection with the polling, query or otherwise, which the workstation 102a stores, logs and/or processes for various uses. In addition field panels 106a and 106b may initiate sending event data to 102a to be stored. To this end, the field panels 106a and 106b are operative to accept modifications, changes, alterations and/or the like (“field panel events”) from the user. Again, field panels 106c and 106d and workstation 102b operate in a similar fashion.

The workstations 102a-102b preferably maintain a database associated with each field panel associated with the workstation. The database maintains operational and configuration data for the associated field panel.

Each workstation 102a-102b is operatively connected to a web server 114 and other supervisory computers, not shown, via the MLN 113 that may suitably be an Ethernet network. Each workstation 102a and 102b uses the MLN 113 to communicate BCS data to and from other elements on the MLN 113, including the web server 114. The database server 104 stores historical data, error data, system configuration data, graphical data and other BCS system information as appropriate. Typically, data stored in workstations 102a-102b is redundantly stored in database server 104. The database server 104 and workstations 102a-102b are then synchronized when communications between them are reconnected.

The MLN 113 may connect to other supervisory computers, not shown, Internet gateways including, by way of example, the web server 114, or other gateways to other external devices, not shown, as well as to additional network managers (which in turn connect to more controllers/subsystems via additional low level data networks). The MLN 113 may suitably comprise an Ethernet or similar wired network and may employ TCP/IP, BACnet, and/or other protocols that support high speed data communications.

The field panels 106a-106d are operative to accept modifications, changes, alterations and/or the like (“field panel events”) from the user with respect to objects defined by the BCS 100. The objects are various parameters, control and/or set points, port modifications, terminal definitions, users, date/time data, alarms and/or alarm definitions, modes, and/or programming of the field panel itself, another field panel, and/or any controller in communication with a field panel. It should here be appreciated that for the below discussion when appropriately referring to FIG. 1, the functionality, features, attributes, characteristics, operation and/or the like of each fault tolerant server or fault tolerant client is the same for every field panel except where indicated, and will be described as such with reference to only field panel 106a. Therefore, the below discussion with reference to field panel 106a is equally applicable to all field panels unless indicated otherwise.

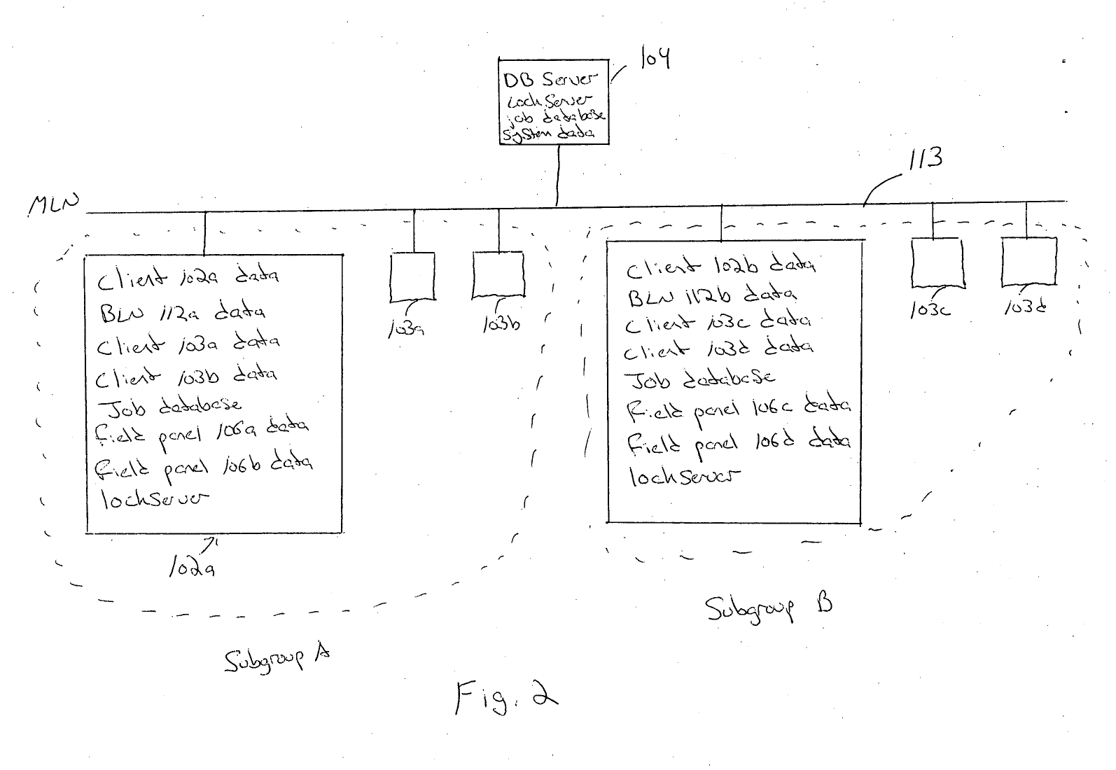

Turning now to FIG. 2, FIG. 2 illustrates workstations 102a and 102b shown in FIG. 1 now provided with sufficient system data to allow workstations 102a-102b and monitoring workstations 103a-103d to continue to operate with at least minimum functionality when communications with the database server 104 are lost. According to the present invention, in order to allow workstations 102a-102b and monitoring workstations 103a-103d to function independently when they are operatively disconnected from the database server 104, copies of the necessary system data may be placed in a database in workstations 102a-102b so that workstation 102a effectively acts as a server for monitoring workstations 103a-103b and workstation 102b effectively acts as a server for monitoring workstations 103c-103d. Accordingly, the solution to system degradability is to divide the system 100 into subgroups A and B, wherein subgroup A comprises workstation 102a and monitoring workstations 103a-103b, and wherein subgroup B comprises workstation 102b and monitoring workstations 103c-103d. In this way, workstations within each subgroup A and B can continue communicating with each other in circumstances where communications are lost with the database server.

One practical advantage of sub-groups is that it allows each subgroup to be UL listed. This advantage will be discussed in further detail below where the present invention is implemented in a life safety system.

As shown in FIG. 2, in order to minimize data storage taken up in each workstation 102a-103b, only copies of data which is pertinent to each fault tolerant workstation 102a-102b will be stored on the respective workstation, instead of copying all the system data from the database server 104 into each workstation 102a-102b. Each autonomous workstation 102a-102b will have local copies of the relevant system, BLN and field panel databases so that the workstations will be able to monitor and control the subsystems they are provided databases for. The data each workstation is provided with includes the physical configuration data for anything that is physically attached to the network that the workstation will be responsible for controlling and monitoring if communications with the database server 104 are interrupted. For example, client 102a is provided with client 102a data, BLN 112a data, client 103a data, client 103b data, field panel 106a data and field panel 106b data, and a copy of the job database. Further, client 102b is provided with client 102b data, BLN 112b data, client 102c data, client 103d data, field panel 106c data and field panel 106d data and a copy of the job database. The workstations are provided with field panel configuration data since the workstations store relevant point data. The workstations need to have BLN configuration data, such as the BLN's name and address, in order to communicate with the field panels.

Workstations 102a-102b are also provided with a job database. The job database contains all of the global information for the entire system. This includes unique naming information and security. This will provide enough security information to allow the system to start up, even if no application can be run. In order to be able to use graphics when a workstation 102a-102b is functioning without the database server 104, all of the graphics files will be copied over to each workstation 102a-102b when it is configured.

Workstations 102a is further provided with configuration data about monitoring workstations 103a-103b, and workstation 102b is further provided with configuration data about monitoring workstations 103c-103d such that workstations 103a-103d can continue provide monitoring functions to users. Workstation 102a and monitoring workstation 103a-103b accordingly form a group that can continue to communicate when communications from the database server 104 are lost. Workstation 102b and monitoring workstations 103c-103d will similarly form a group that can continue to operate once communications from database server 104 are lost. Accordingly, workstation 102a will not be able to enable monitoring or control over the bln2 112b with field panels 106c-106d, and workstation 102b will have similar limitations. In the present embodiment, workstations 103a-103b will only be able to monitor bln1 112a and field panels 106a-106b, and workstations 103c-103d will only be able to monitor bln2 112b and field panels 106c-106d. In alternative embodiment, further configuration data can be provided to workstations 102a and 102b such that they are capable of controlling and monitoring any device within building control system 100.

Each workstation 102a-102b is further provided with a lockserver, which is an Objectivity service that allows databases to function on a particular workstation. In a preferred embodiment, lockservers are only provided to a limited number of workstations, 102a and 102b for example, due to limited MLN bandwidth.

When communications are lost between the fault tolerant workstations 102a-102b and the database server 104 for a predetermined amount of time, the system 100 will display on the workstation 102a-102b interface that the workstation will begin functioning in fault tolerant mode, so that the user understands that the workstation will be operating with limited functionality. For functions that are disabled, the only action the user can take is to shut them down. When connections are reestablished between the database server 104 and the workstation, the workstation will receive a message that the workstation is no longer in fault tolerant mode. Any updates made at the database server 104 will be passed onto the workstation. In this embodiment, the database server 104 will be able to track the availability of fault tolerant workstations 102a-102b by checking lockserver availability.

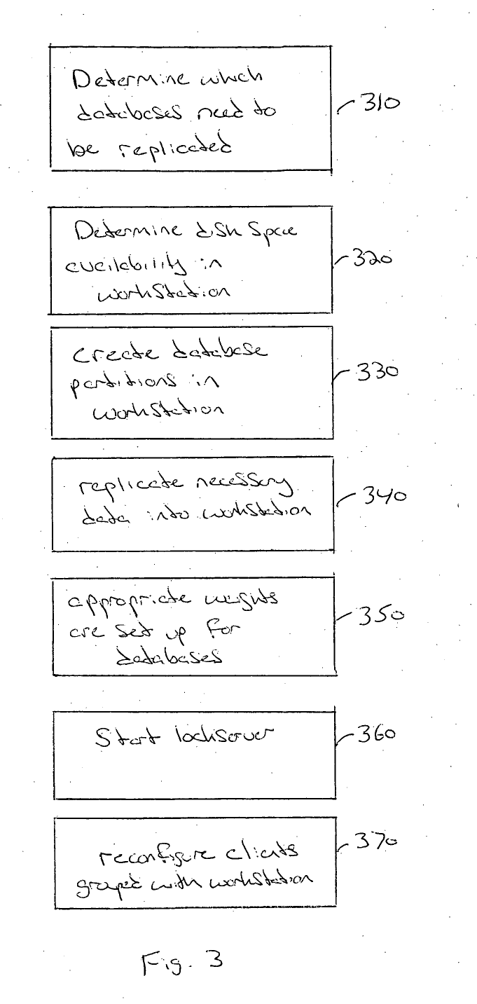

Referring now to FIG. 3, there is depicted a flowchart, generally designated 300, of an exemplary manner of operation of the subject invention. This flowchart 300 is described with reference to converting a normal workstation to a fault tolerant server or workstation. It should be appreciated that the steps depicted in the flowchart 300 of FIG. 3 is only exemplary of one manner in which the subject invention functions. Other manners, as well as additional steps, less steps, or modified steps constitute valid functioning of the subject invention in accordance with the present principles.

The flowchart 300 begins with step 310. In step 310, the user will need to determine which databases in database server 104 need to be replicated. For example, for turning workstation 102a into a fault tolerant workstation, workstation 102a requires workstation 102a data, BLN 112a data, client 103a data, client 103b data, field panel 106a data and field panel 106b data, a copy of the job database and a lockserver in order to function as a fault tolerant workstation. In step 320, it will be necessary to determine that the workstation 102a has the available disk space to store the necessary data. In step 330, the appropriate partitions, which are objectivity constructs for distributing data, are created on workstation 102a for the system databases. In step 340, the necessary databases and graphics files are replicated into the workstation 102a. In step 350, the appropriate weights on each database are set up in the workstation 102a. In step 360, the lockserver for workstation 102a is started. The workstation 102a is then capable of operating as a fault tolerant workstation. In step 370, clients 103a-103b are reconfigured to use the lockserver for workstation 102a instead of the lockserver of the database server 104 when communications between the clients 103a-103b and the database server 104 are lost. The same reconfiguration is done for clients 103c-103d with respect to the lockserver for workstation 102b.

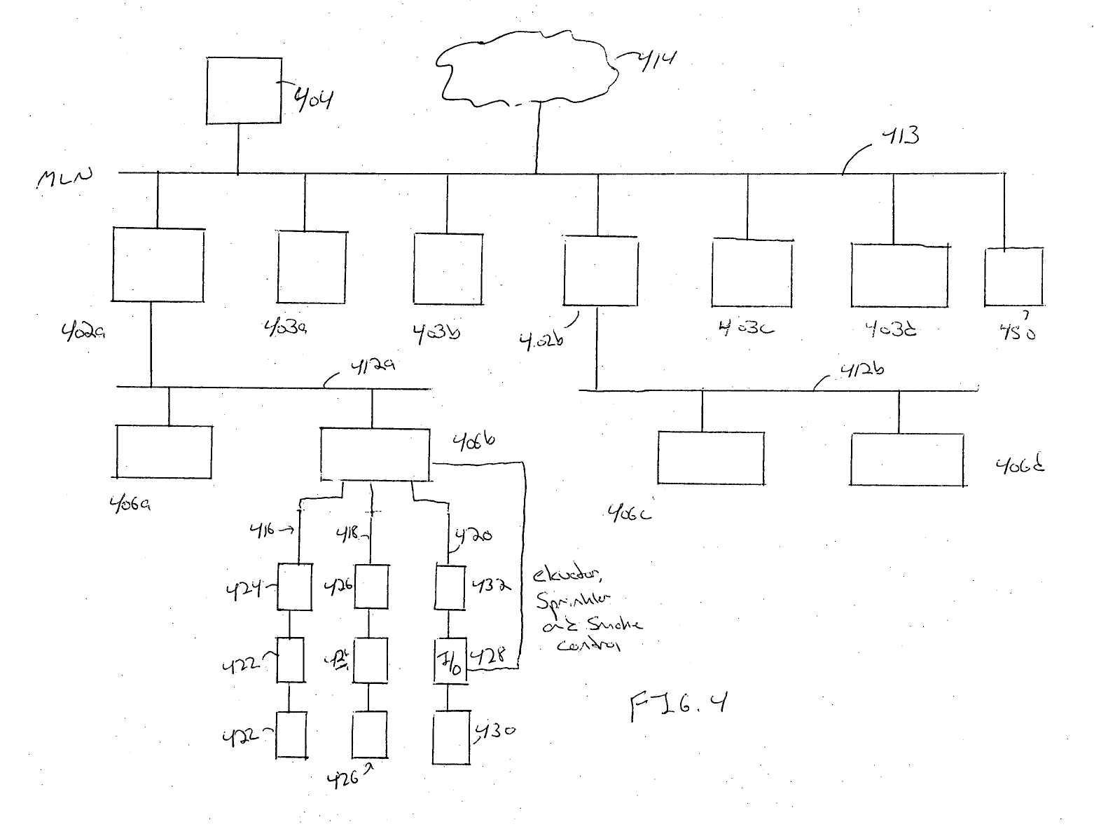

In another embodiment, shown in FIG. 4, the present invention discussed with respect to FIGS. 1-3 is implemented as a life safety system. The problem with existing life safety systems is that in circumstances when clients cannot communicate with the database server, the ability of the system to record and report alarm events is greatly diminished. In the present invention, workstations 402a and 402b will be enabled to view and acknowledge its own alarms when the database server 404 cannot be reached. In the present invention, field panels 406a-406d are provided as fire safety panels, such as the FireFinder XLS Fire Safety Panel sold by Siemens Building Technologies, and described in co-pending patent application Ser. No. 10/199,802. A key requirement of life safety systems is the ability to display, acknowledge to the field panels and record (to a local printer) all fire alarm activity. The Database server 404 can view any alarm that came in while the clients 402a and/or client 402b are still connected, and can acknowledge those alarms. New alarms coming into the off-line client 402a or 402b will be queued up and sent once communication between the client and the database server 504 are communicating again. When database server 404 is not available, workstation 402a or any workstation in its group (workstations 403a-403b) can view and acknowledge alarms on bLN 412a. In a similar fashion, when database server 404 is not available, workstation 402b or any workstations in its group (403a-403b) can view and acknowledge alarms on bin 412b.

A typical fire safety system network is shown in FIG. 4. The network 400 in the embodiment described herein actually involves several layers of interconnected subnetworks, including a management level network MLN 413, one or more building level networks BLN1 412a and BLN2 412b, and one or more floor level networks associated with each building level network. For example, floor level networks 416, 418 and 420 are associated with the BLN1 412a.

The MLN 413, which preferably includes an Ethernet standard network employing TCP/IP protocol, includes a plurality of workstations, represented herein as workstations 402a and 402b that provide a graphical and/or text-based user interface for the fire safety system. Each of the workstations 402a, 402b is also connected to a set of fire safety devices via a lower level BLN. The workstations 402a, 402b and 403a-403d employ the MLN to share data received from such devices.

In accordance with good building engineering practices, the workstations 402a, 402b are PCs that are UL (Underwriter's Laboratories) listed for fire protective signaling use. The UL listing indicates that the component has been tested to meet a particular standard. In the case of fire control and alarm systems, the industry accepted standard is published by the National Fire Prevention Association (NFPA) and takes into account various government standards applicable to fire safety. The NFPA publishes the National Fire Alarm Code (NFPA 72), the Life Safety Code (NFPA 101), Recommended Practices for Smoke-Control System (NFPA 92A) and other related standards. All of these standards are recognized as an American National Standard for the engineering, installation and maintenance of fire safety systems for buildings/facilities of all types. All fire alarm/control systems should utilize only components that are UL certified for use in fire protective signaling.

In further detail of the fire safety devices, the workstation 402a is connected to a first building level network BLN1 412a that facilitates communication with and among a number of fire control panels 506a, 506b that monitor and control various fire devices and functions. These fire control panels are also UL listed for fire protective signaling use. These panels 406a, 406b are specialized hardware devices that connect to networks of fire detection and notification devices, as well as providing other fire control functions. One such fire control panel is the FireFinder panel produced and sold by Siemens Building Technologies, Inc. In general, the FireFinder fire control panel includes a central processor, battery back-up, a network interface card, connections for a number of fire device networks, connections for a firefighter's phone system, dry contacts for additional functions, and a user interface including status indicators. The network interface card for each of the fire control panels 406a allows communication among all of the panels 406b and with the fire control workstation 402a.

The workstation 402a can be regarded as residing at a management level of the fire safety system 400. The fire control panels 406a, 406b form part of the BLN1 412a. As shown in FIG. 4, at least one of the of the fire control panels 406b is further connected to a plurality of floor level or device networks 416, 418 and 420 that include the fire control devices themselves. Each type of device is preferably connected to a common fire control panel that monitors the associated device network for trouble, receives signals from and sends signals to the device network, and usually provides power to the devices on the network. The associated fire control panel 406b also includes means to test the integrity of the device network 416, 418, 420, and connected fire control devices and to produce a trouble signal, in the event of a malfunction or anomaly, that is communicated to the management level fire control workstation 402a.

The workstation 402b is similarly connected to a building level network BLN2 412b to which is connected a number of fire control panels 406c, 406d. The fire control panels 406c, 406d are typically each connected to floor level networks, not shown, but which are similar to networks 416, 418, 420.

The device networks accommodate different fire control devices. For instance, network 416 includes Initiating Device Circuits (IDCs), which can include smoke detectors 422 and pull switches 424. The device network 418 includes Notification Appliance Circuits (NACs) 426 that are similar to IDCs but include a notification device, such as horns, strobes or speakers. The fire control panel 406b associated with each of these networks continuously monitors the integrity of these networks 416, 418 by passing a low level current through the circuits of the IDCs 422, 424 and the NACs 426. Any disruption in this continuous current (that is not associated with an alarm condition) is identified by the fire control panel as an error condition giving rise to a trouble signal.

The device network 420 can be an Addressable Loop 428, which is a network of addressed devices so that the fire control panel can selectively receive and transmit signals from detection devices on the loop. As shown in the example of FIG. 5, the addressable loop 428 includes an IDC smoke detector 430 and a pull switch 432. Unlike the device networks 416 and 418, the addressable loop 428 of the network 420 does not use a continuous signal to monitor its integrity. Since all of the devices on the loop 428 are assigned an address, the fire control panel can routinely communicate with these devices to see if they are still available. A failure to communicate with a particular addressed device causes the control panel 406b to generate a trouble signal that is supplied to the management level workstation 402a.

In order to eliminate the need for a database server 404 that's UL Listed for life safety systems, or to allow workstations 402a and 402b to function when communications are interrupted between the workstations and the database server, workstations 402a-402b are provided with similar information that the workstations 102a-102b are provided in FIGS. 1 and 3. For example, workstation 402a is provided with client 402a data, BLN 412a data, client 403a data, client 403b data, field panel 406a data and field panel 406b data. Further, workstation 402b is provided with client 402b data, BLN 412b data, client 402c data, client 403d data, field panel 406c data and field panel 406d data and a copy of the job database.

According to the present invention, even when no database server 404 is provided, or when communications are lost between the database server 404 and the workstations, workstations 402a-402b are able to display alarms on their respective displays, such as the display shown in copending application Ser. No. 10/434,390, which is incorporated by reference herein, the point designation of the alarm, which may include information such as the name of the point, or the address of the point within the system. The display should also include information such as alarm status (Alarm, Supervisor, Trouble, etc.) and date and time. In the present invention, the user will be able to acknowledge alarms from the workstation 402a, send alarms to the panel 406b, and send an acknowledge alarm message to printer 450. As the UL Listed workstations 402a, 403a, 403b and workstations 402b, 403c and 403d are provided as groups, alarm ownership may be transferred between fire workstations in each group.

It will be appreciated that the above-described embodiments are merely exemplary, and that those of ordinary skill in the art may readily devise their own implementations and modifications that incorporate the principles of the present invention and fall within the spirit and scope thereof.

1) A fault tolerant building control system comprising:
a database server for storing information about the building control system;
one or more clients, each client provided for monitoring and controlling a building control subsystem, wherein said client is provided with a database for storing data about the building subsystem from the database server such that the client will be able to continue monitoring and controlling said building subsystem if said client becomes operatively disconnected from said database server such that said client becomes a fault tolerant server.

2) The system according to claim 2, wherein the information shared with each fault tolerant server includes information about the subnetwork the fault tolerant server is connected to.

3) The system according to claim 3, wherein the subnetwork is a building level network.

4) The system according to claim 2, wherein the data stored in the fault tolerant server includes information about each controller connected to said subnetwork so that the fault tolerant server can continue communicating with the controllers after communications between the fault tolerant server and the database server are disconnected.

5) The system according to claim 1, further comprising one or more clients, operatively connected to said fault tolerant server, wherein said data stored in said fault tolerant server database includes information about said one or more clients such that said clients can continue monitoring said subsystem after communications with said database server are interrupted as long as communications between said client and said fault tolerant server are maintained.

6) The system according to claim 1, further comprising one or more clients operatively provided to monitor subsystems, wherein data about each said client is assigned to a workstation such that said client can only monitor the subsystem the fault tolerant server has data for.

7) The system according to claim 1, wherein each said fault tolerant server is capable of acknowledging alarm events received from a controller.

8) The system according to claim 1, wherein the fault tolerant server is capable of displaying alarm information.

9) The system according to claim 1, wherein the fault tolerant server is capable of recording information about an alarm.

10) The system according to claim 1, wherein subsystem data is stored at the fault tolerant server, and is transmitted to the database server once connection between the fault tolerant server and the database server are reestablished.

11) The system according to claim 1, wherein changes to data stored at the database server are transmitted to the fault tolerant server once communications between the database server and the fault tolerant client are reestablished.

12) The system according to claim 10, wherein the subsystem data includes alarm data.

13) The system according to claim 1, further comprising a client display for displaying a message on said display of said fault tolerant server that said database server is unavailable due to network or system failures, or a combination thereof.

14) The system according to claim 1, wherein the database server is capable of determining the availability of fault tolerant clients by checking lock server availability.

15) The system according to claim 1, wherein the fault tolerant server is capable of determining database server availability by checking lock server availability.

16) The system according to claim 1, wherein a plurality of fault tolerant servers are provided, each fault tolerant server grouped with one or more clients such that the fault tolerant server and the clients the fault tolerant server are grouped with can continue communicating after communications between the database server each fault tolerant server group are lost.

17) A method of converting a server dependant client to a fault-tolerant server comprising, wherein said server dependant client is operatively connected to a database server, said database server having system information necessary for the system to operate, the method comprising:
determining which databases in said databases server need to be replicated into client such that said client can operate as a fault-tolerant server;
determining available disk space for said client;
establishing appropriate partitions in the database of the client;
replicating databases from said database server into said fault tolerant server database, said databases including information about one or more clients grouped with the fault tolerant server such that the fault tolerant server and the fault tolerant clients can communicate when the clients and the fault tolerant server are unable to communicate with the database server;
establishing weights on each database; and
starting the lockserver transferred to the fault-tolerant server

18) The method according to claim 17, wherein clients are reconfigured to use the fault tolerant lockserver instead of a lockserver of the database server when communications between the clients and the database server are lost.

19) The method according to claim 17, wherein the databases replicated into the fault tolerant server include data about the subnetwork the fault tolerant server is connected to such that the fault tolerant server can communicate with the subnetwork when the fault tolerant server is unable to communicate with the database server.

20) The method according to claim 19, wherein the databases replicated into the fault tolerant server include data about the field panels connected said subnetwork so that the fault tolerant client can communicate with the field panels when the fault tolerant client is unable to communicate with the database server.
